(19) United States
(12) Patent Application Publication
(10) Pub. No.: US 2016/0153787 A1
(43) Pub. Date: Jun. 2, 2016

(54) METHOD AND SYSTEM FOR DIVISION OF ROAD NETWORK

(71) Applicant: INTERNATIONAL BUSINESS MACHINES CORPORATION, ARMONK, NY (US)

(72) Inventors: WEI SHAN DONG, BEIJING (CN); NING DUAN, BEIJING (CN); PENG GAO, BEIJING (CN); GUOQIANG HU, SHANGHAI (CN); JIAN GONG WANG, NINGBO (CN); ZHI HU WANG, BEIJING (CN); XIN ZHANG, BEIJING (CN)

(21) Appl. No.: 14/939,091

(22) Filed: Nov. 12, 2015

(30) Foreign Application Priority Data
Nov. 28, 2014 (CN) 201410710995.0

(51) Int. Cl. G01C 21/26; G06F 3/0484; G01C 21/20

(52) U.S. Cl. CPC G01C 21/26; G01C 21/20; G06F 3/0484

(57) ABSTRACT

Embodiments include methods and systems for dividing a road network. Aspects include obtaining a common endpoint on the road network based on a first set of trajectories and aggregating, based on orientations of a second set of trajectories at a plurality of nodes on the road network, the plurality of nodes starting from the common endpoint, so as to generate an aggregated nod. Aspects also include dividing the road network using the aggregated node.

### FOREIGN PRIORITY

This application claims priority to Chinese Patent Application No. 201410710995.0; filed Nov. 28, 2014; and all the benefits accruing therefrom under 35 U.S.C. §119, the contents of which in its entirety are herein incorporated by reference.

### BACKGROUND

Embodiments of the present invention relate to the field of intelligent transportation, and more specifically to a method and system for dividing a road network.

In various fields such as Internet of vehicles, intelligent transportation, and location-based services (LBS), map is fundamental information supporting other services. In particular, a road network of the map includes road segment information for indicating information regarding roads and traffic routes. Based on the information provided by the road network, travel trajectory and/or other information of a subject (e.g., a pedestrian, a vehicle) during a movement process may be obtained and processed.

During gathering and processing mass vehicle data and/or during online Internet of Vehicles services, an Internet of Vehicles integrated service platform has to process trajectory data and other data in a distributive manner so as to guarantee the extensibility of the system. Specifically, a road network needs to be divided into a plurality of areas. Data of each area is processed by one or more servers. In road network division, a plurality of factors need to be taken into account, e.g., load balance between different servers, times of a vehicle or pedestrian crossing different areas, etc. It would be appreciated that when the vehicle or pedestrian frequently moves across different areas, data overheads regarding data synchronization and service handover will be incurred.

A traditional solution takes road network division as a global optimization issue to be modeled and processed. For example, road segments in a road network may be assigned corresponding weights. An optimization objective may be set to minimizing the total sum of the weights of the divided road segments. Meanwhile, it may be required that differences between total sums of road segment weights in respective divided areas should be within a given range. It is a process with huge calculation overheads, which can be barely applied to mass data of a road network in a real world. A heuristic algorithm has been proposed to randomly divide the road network. However, the heuristic algorithm is a process of multiple rounds of iteration, which cannot ensure a satisfactory division effect.

### SUMMARY

In one aspect, embodiments of the present invention provide a method for dividing a road network. The method comprises: obtaining a common endpoint on the road network based on a first set of trajectories; aggregating, based on orientations of a second set of trajectories at a plurality of nodes on the road network, the plurality of nodes starting from the common endpoint, so as to generate an aggregated node; and dividing the road network using the aggregated node.

In another aspect, embodiments of the present invention provide a system for dividing a road network. The system comprises: a common endpoint obtaining unit configured to obtain a common endpoint on the road network based on a first set of trajectories; a node aggregating unit configured to aggregate, based on orientations of a second set of trajectories at a plurality of nodes on the road network, the plurality of nodes starting from the common endpoint, so as to generate an aggregated node; and a road network dividing unit configured to divide the road network using the aggregated node.

It would be appreciated through the description below that according to embodiments of the present invention, association between nodes in a to-be-divided road network in terms of geology and/or traffic can be effectively identified. With such association, the initial road network can be effectively simplified. Therefore, road network division can be performed efficiently. Other features and advantages of the present invention will become easily comprehensible through the description below.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an exemplary computer system/server which is applicable to implement embodiments of the present invention;

FIG. 2 shows a schematic flow diagram of a method for dividing a road network according to an embodiment of the present invention;

FIG. 3 shows a schematic diagram of obtaining a common endpoint through aggregating trajectory endpoints according to an embodiment of the present invention;

FIG. 4 shows a schematic diagram of orientations of trajectories at a node according to an embodiment of the present invention;

FIG. 5 shows a schematic diagram of calculating entropy associated with a node which indicates diffusiveness of trajectory orientations according to an embodiment of the present invention;

FIG. 6 shows a schematic diagram of node aggregation according to an embodiment of the present invention;

FIG. 7 shows a schematic block diagram of a system for dividing a road network according to an embodiment of the present invention.

### DETAILED DESCRIPTION

Exemplary embodiments will be described in more detail with reference to the accompanying drawings, where the exemplary embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

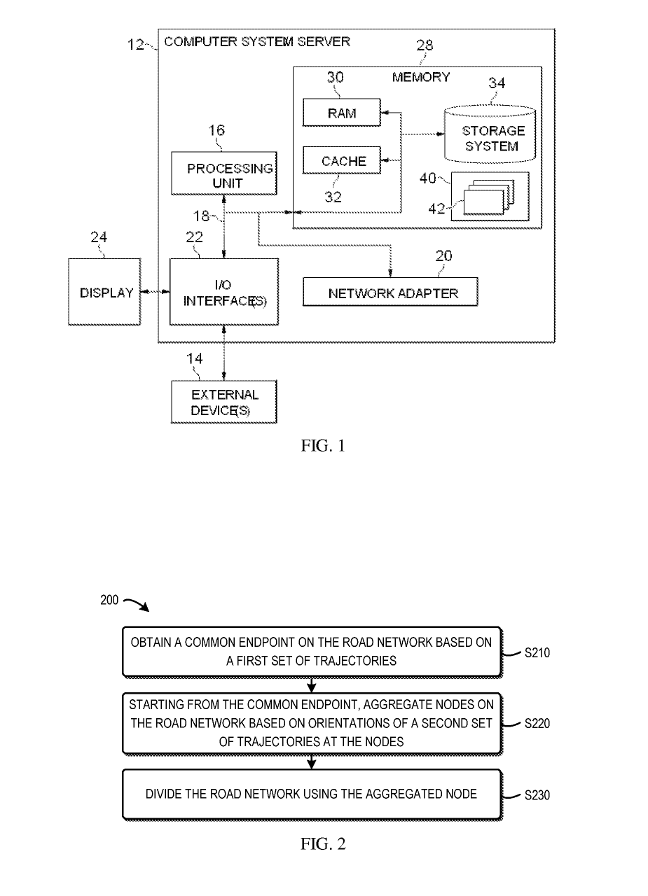

Referring now to FIG. 1, where an exemplary computer system/server 12 which is applicable to implement embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically referred to as a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

Hereinafter, the mechanism and principle of embodiments of the present invention will be described in detail. Unless otherwise stated, the term “based on” used hereinafter and in the claims expresses “at least partially based on.” The term “comprise” or “include” or a similar expression indicates an open inclusion, i.e., “including, but not limited to . . . . ” The term “plural” or a similar expression indicates “two or more.” The term “one embodiment” indicates “at least one embodiment.” The term “another embodiment” indicates “at least one another embodiment.” Definitions of other terms will be provided in the description infra.

FIG. 2 shows a schematic flow diagram of a method 200 for dividing a road network according to an embodiment of the present invention. As mentioned above, a road network is a map at least containing road or traffic route information within a relevant geographical area. For example, the road network may include a plurality of road segments indicating route information. Of course, the road network may also contain other geographical information.

The method 200 starts at block S210, where a common endpoint on a to-be-divided road network is obtained based on a set of trajectories (referred to as “a first set of trajectories”). The term “trajectory” used here refers to a travel line of a subject during a movement process, which is obtained through tracking and detecting the movement of the subject. The term “subject” used here refers to a pedestrian, vehicle and/or any other person or device that can collect location data.

In one embodiment, during the movement process of the subject, a location/navigation device (e.g., GPS receiver) associated with the subject may sense the location of the subject. These locations form the trajectory of the subject. In one embodiment, the location/navigation device periodically senses the location data of the subject according to a given time interval. In another embodiment, the location data may also be continuously obtained. The location data may be stored locally at the subject, and/or stored in a machine (e.g., server) remote to the subject. Alternatively or additionally, the location data during the travel process of the subject may also be obtained from the third party.

For example, many devices such as a vehicle, a mobile phone, a tablet computer, and a personal digital assistant (PDA) have been equipped with a global positioning system (GPS) or other navigation/positioning system. When a vehicle or pedestrian travels along a specific route, the navigation/positioning system can continuously or periodically collect location data to form a travel trajectory.

In one embodiment, location data, for example, may comprise latitude and altitude coordinates. Of course, any other form of location data is also feasible. Alternatively, in one embodiment, for a location of the subject in the trajectory, the location data may also indicate one or more items of the following: time when the subject arrives at the location, movement velocity of the subject at the location, and movement orientation of the subject at the location, etc.

The trajectory may be mapped to a road network. According to embodiments of the present invention, any appropriate technology may be used to complete a mapping from the travel trajectory to the road network. For example, in one embodiment, a map matching technology may be used. As is already known, given a travel trajectory represented by multiple locations, the map matching process may determine points in the road network corresponding to these points through coordinate conversion, and find a matching route for the travel trajectory in the road network.

Various kinds of map matching technologies may be used in combination with embodiments of the present invention. For example, in one embodiment, a matching degree between a travel trajectory and a route may be determined using a cross-correlation method. Alternatively, a sequential detection method, a hierarchical search method, and an edge feature matching method or the like may be employed. Alternatively, besides the path matching the travel trajectory, in one embodiment, the map matching process may also provide a matching degree between the travel trajectory and respective road segments in the matching route. The map matching technology per se is already known, which will not be detailed here. Any other mapping technology is also possible, regardless of what is currently known or future developed.

As shown at block S210, a first set of trajectories from one or more subjects may be analyzed to identify a common endpoint. In the context of the present disclosure, the term “endpoint” may represent a start point or a terminal point. As shown at block S210, the specific path through which the trajectory passes may not be considered, while only the start point and the terminal point of the trajectory are considered. For example, if trajectories exceeding a predetermined number or percentage in the first set of trajectories start from a certain start point, then the start point may be regarded as a common point Likewise, a common terminal point in the road network may be identified.

In particular, in one embodiment, the common endpoint may not be an actual trajectory endpoint of any specific trajectory in the first set of trajectories, but a result of aggregating multiple trajectory endpoints by distance. In one embodiment, these actual endpoints may be aggregated based on a distance between actual trajectory endpoints in the first set of trajectories so as to obtain a common endpoint. Only for the sake of illustration, discussion will be made with a common start point as an example. It would be appreciated that a common terminal point may also be obtained in a similar manner.

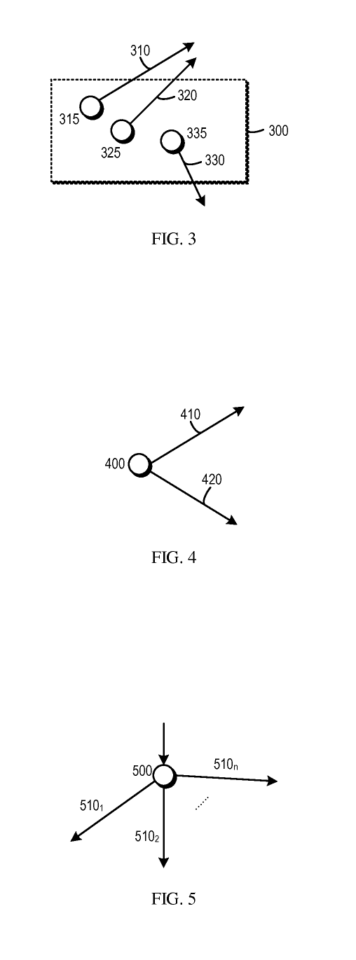

Specifically, if trajectory start points of multiple trajectories are concentrated in a certain predetermined proximity, the specific proximity may be determined as a common start point. The term “proximity” used here refers to an area having a specific size and shape on the map. In this case, a common start point covers actual trajectory start points of multiple trajectories. As an example, in the embodiment as shown in FIG. 3, the rectangular proximity 300 is determined as a common start point, which covers respective trajectory start points 315, 325, and 335 of trajectories 310, 320, and 330 in the first set of trajectories. The distance among the trajectory start points 315, 325, and 335 are less than a predetermined threshold distance. It is seen that at this point, the matching degree of the trajectories are not considered. For example, trajectories 310 and 320 and the trajectory 330 have obvious orientation offset.

It would be appreciated that the embodiments of FIG. 3 are only exemplary, not intended to limit the scope of the present invention in any manner. For example, the scope of a common endpoint obtained through aggregation is not necessarily a scope. For example, in an alternative embodiment, locations of multiple trajectory endpoints whose distances are lower than a predetermined threshold distance may be averaged or subject to other operations, thereby obtaining an aggregated endpoint.

Continue reference to FIG. 2. The method 200 proceeds to block S220, where multiple nodes in the road network are aggregated based on a set of trajectories (referred to as “a second set of trajectories”) and the common endpoint at block S210. It should be noted that the second set of trajectories used at block S220 and the first set of trajectories used at block S210 may be identical or different.

More specifically, according to the embodiments in the present invention, starting from the common endpoint determined at block S210, nodes are aggregated based on orientations of the trajectories at multiple nodes in the road network along a forward or reverse orientations of the second set of trajectories. In one embodiment, the to-be-aggregated nodes may be intersections, bifurcations, junctions of road segments in the road network or any nodes of a transportation or geographical sense. In one embodiment, for a common start point, aggregation may be performed along forward directions of corresponding trajectories; for a common terminal point, aggregation of nodes may be performed along reverse orientations of corresponding trajectories.

In one embodiment, by performing aggregation at block S220, nodes of an identical or similar geographical or transportation sense may be aggregated together to form an “aggregated node.” The aggregated node has an explicit transportation or geographical sense. For example, through orientation analysis of the trajectories at a node, a concentrated resident zone, business office zone or like functional regions may be identified. Therefore, in subsequent division, data of these functional regions may be assigned to one or more servers to process, thereby reducing data migration.

In one embodiment, for any given node in a road network, a diffusiveness of orientations of at least some trajectories in the second set of trajectories through the node may be determined, and nodes may be aggregated based on such orientation diffusiveness. The following hypothesis is based: if the diffusiveness of a trajectory orientation at one node is relatively high (i.e., a low regularity), it very likely indicates that the node is located at a demarcation node between different functional regions. For example, in an entry and exit of a link road connecting a living community and a working zone, a subject always travels along one or a few of orientations.

Based on such hypothesis, in one embodiment, if the diffusiveness of orientations of multiple trajectories at a given node is higher than a predetermined threshold, the node and other nodes in the road network may be aggregated. For example, in one embodiment, if the aggregation operation is performed starting from a common start point along a forward orientation of the trajectory, the given node and previous nodes in the trajectory may be aggregated. Otherwise, if the aggregation operation is performed from a common start point along a reverse direction of the trajectory, the given node may be aggregated with subsequent nodes in the trajectory. Of course, when determining whether to aggregate two nodes, other factors may also be considered. An embodiment in this aspect will be described below.

On the other hand, if the diffusiveness of orientations of multiple trajectories at a given node is lower than a predetermined threshold, then the node may be kept in the road network. In other words, in this case, the node may be used as an independent road network node in subsequent road network division.

According to embodiments of the present invention, the diffusiveness of the trajectory at any given node may be measured through various appropriate technical means. Consider an embodiment of aggregating from the common start point along a forward orientation of the trajectory as an example. In this case, for a given node, orientations in which multiple trajectories arriving at the node leave the node may be counted. If the number of trajectories leaving the node along an orientation are dominant (e.g., exceeding a predetermined percentage), it may be believed that the diffusiveness of the orientations of the trajectories associated with the node is relatively low.

With reference to FIG. 4, suppose there are 50 routes arriving at the node 400. If the gap between the numbers of trajectories leaving the node 400 along orientations 410 and 420 is relatively large, for example, 40 pieces and 10 pieces, respectively, it is believed that the diffusiveness of the trajectories at node 400 is very low. Otherwise, if the difference between the numbers of trajectories leaving the node 400 along orientations 410 and 420 is relatively small (for example, 26 pieces and 24 pieces, respectively), then the diffusiveness of the trajectories at node 400 is considered to be relatively high. For the reverse aggregation which starts from the common terminal point, the diffusiveness of the orientations of the trajectories at the given node may be determined in a similar manner.

In particular, in one embodiment, entropy may be used to quantitatively represent the diffusiveness of the orientations of the trajectories at a given node. As is already known, if node aggregation is performed from a common start point along a forward orientation of the trajectory, the entropy of the diffusiveness of the trajectories associated with the given node may be calculated based on a percentage between trajectories extending along different orientations from the given node in the second set of trajectories.

Refer to FIG. 5. In this example, aggregation proceeds to node 500 along a forward orientation of the path. Suppose the ratios of the numbers of trajectories continuously extending along three directions 5101, 5102, . . . , 510n (n is a natural integer greater than 2) over the total number of trajectories arriving at the node 500 are P1, P2, . . . , Pn, respectively. In one embodiment, the entropy associated with the node 500 (which is described as diffusiveness of trajectory orientations) may be calculated as follows:

H=−(P₁·log P₁+P₂·log P₂+ . . . +Pₙ·log Pₙ)

Likewise, when the node aggregation is performed from a common terminal point along a reverse orientation of the trajectory, the entropy associated with the given node 500 may be calculated based on the ratios between trajectories arriving at the given node from different orientations in the second set of trajectories.

According to embodiments of the present invention, the node aggregation at block S220 can be done based on other factor than the diffusiveness of trajectory orientations. Alternatively, or in addition, the distance between the nodes can be taken into consideration. For example, in one embodiment, both the diffusiveness of trajectory orientations and the distance between the nodes can be used.

For example, in one embodiment, if it is determined that the diffusiveness of trajectory orientations at a given node is greater than a predetermined threshold, a distance between the node and its corresponding upstream or downstream node (depending on whether the aggregation operation starts from a common start point or a common terminal point) may be further determined. If the distance is likewise less than a predetermined threshold distance, aggregation may be performed. In another embodiment, a distance between nodes may be considered in priority.

It is to be understood that the diffusiveness of trajectory orientations at a node and the distance between nodes may be used in combination in any suitable ways. For example, in one embodiment, the distance between two nodes may be weighted using the number of trajectories between these two nodes or the ratio between the trajectories connecting these two nodes and all trajectories. Then, with the above equation, the entropy is calculated based on the weighted distance. In this way, the aggregation of nodes may be done by taking into consideration both the diffusiveness of the trajectory orientations and the distribution density of the nodes.

In those embodiments where a node distribution density is taken into consideration, node aggregation performed at block S220 may guarantee that the aggregated nodes not only have a greater diffusiveness of trajectory orientations, but also have a higher distribution density. In this way, it helps further avoid cross-node data access and data migration in subsequent road network division. Of course, it is fully feasible to consider the diffusiveness of trajectory orientations alone.

It would be appreciated that through aggregation at block S220, some original nodes in the road network are merged into aggregated nodes, while some other nodes are maintained. In this way, the road network will be simplified. Each aggregated node will replace a relevant original node. In one embodiment, the aggregated nodes may also replace a common start point or a common terminal point associated therewith. In this way, the road network may be further simplified.

As an example, for an inter-city road network, by appropriately setting a threshold, nodes belonging to one city or area may be merged into aggregated nodes, while maintaining the original road network nodes on a link road segment (e.g., highway) between the cities. For a road network within a city, nodes may be aggregated according to functional regions (living zone, leisure zone, working zone, etc.), meanwhile maintaining the original road network nodes on the linking road segment between these functional regions.

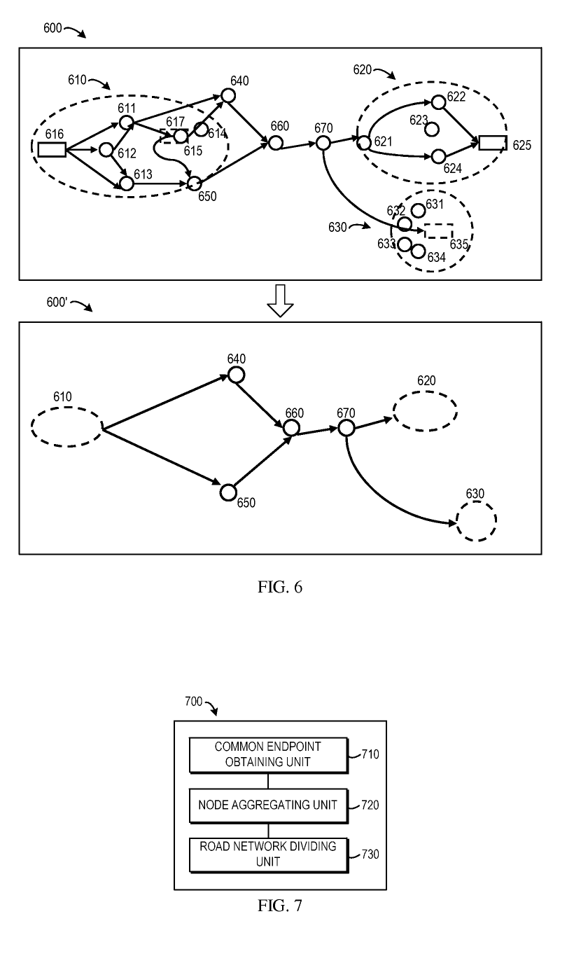

FIG. 6 shows a specific example. In the example of FIG. 6, during the process of node aggregation, the diffusiveness of trajectory orientations at a node and the distance between nodes are simultaneously considered. Therefore, the original nodes 611-615 in the road network and the common endpoints 616 and 617 obtained through aggregating trajectory endpoints of the first set of trajectories are replaced by the aggregated endpoint 610. This is because at these original nodes, the diffusiveness of the trajectories and/or the distribution density are relatively high. Likewise, the original nodes 621-624 and the common endpoint 625 are replaced by the aggregated node 620. The original nodes 631-634 and the common endpoint 635 are replaced by the aggregated node 630.

In this way, the original road network 600 is simplified as road network 600′. The simplified road network 600′ includes aggregated nodes 610, 620, and 630, as well as the original nodes 640-670 in the original road network 600. These original nodes are maintained in the simplified road network 600′ because of the relatively low diffusiveness of trajectory orientations and/or relatively large distances from other nodes.

Still in reference to FIG. 2. The method 200 proceeds to block S230, where a road network is divided using aggregated nodes. In one embodiment, the nodes in the road network may be converted into a graph, wherein nodes in the road network are nodes (original nodes and/or aggregated nodes) of the graph. An edge between nodes may be created based on factors such as road link relationship and trajectories in the road network. Based on such graph model, any currently known or future developed algorithms, such as global optimization, heuristic algorithm or the like, may be used for dividing the road network into a plurality of areas. This is known in the art and will not be detailed here.

In particular, as is already known, during division of road network, a weight of an edge that connects nodes will have an influence on an object to be optimized. For example, the object to be optimized may be set to minimizing the total sum of weights of divided road segments. Additionally or alternatively, it may be required that the difference between total sums of weights of road segments in respective divided areas is within a given range.

According to embodiments of the present invention, in a simplified road network, a weight between two original nodes may be determined based on relevant trajectory orientation and/or distance. For example, in one embodiment, the weight between two original nodes may be determined based on a road network distance between the two original nodes and the number or percentage of trajectories between two original nodes.

For an aggregated node, a weight of the edge between the aggregated node and a further node may be determined based on the weight between one or more nodes covered by the aggregated node and the further node (the original node or a further aggregated node). For example, in the example shown in FIG. 6, suppose in the aggregated node 610, the weight from the node 611 to the node 640 is w1, and the weight from the n ode 615 to the node 640 is w2. In one embodiment, the weight from the aggregated node 610 to the original node 640 may be determined by summing w1 and w2 or through any other appropriate operation.

In particular, in one embodiment, in a graph-based road network division, a weight of an edge between nodes may be adjusted based on the length of the trajectory. Specifically, it is aware based thereupon that when the trajectory is relatively short, it should be tried to keep the trajectory from being segmented into different divided regions. Otherwise, when the trajectory is rather long, it would be inevitable for appropriately crossing regions.

Therefore, an appropriate trajectory length threshold may be set. For example, in one embodiment, such a length threshold may be selected based on an average length of respective trajectories in the second set of trajectories. If the length of a trajectory exceeds the length threshold, contribution of the trajectory to a weight of a relevant edge will be at least partially reduced.

For example, in one embodiment, shares of weights of an edge between nodes by each trajectory are originally equal, e.g., both being set to “1.” Namely, when a trajectory extends to B through node A, the weight of the edge in the graph between nodes A and B will increment by 1. However, if a length of a trajectory exceeds a length threshold, its contribution to the weight of the edge may be appropriately down-adjusted, e.g., down-adjusted to 0.8 or any appropriate value.

In one embodiment, contributions of a trajectory whose length exceeding a threshold to weights for all relevant edges are reduced. Alternatively, in another embodiment, only the contributions of the weights of those parts of trajectories that exceed the threshold length to the relevant edges are down-adjusted. Moreover, in one embodiment, lowering of weights may be progressive. Namely, with the increase of the length of a trajectory, its sharing with edge weight is gradually lowered time by time.

With the method 200, geographical and/or transportation association between road network nodes may be effectively identified, and the initial road network is simplified using such association. Therefore, the road network can be divided in a relatively efficient way even if a global optimization having a relatively high computational cost is used.

FIG. 7 shows an exemplary block diagram of a system 700 for dividing a road network according to an embodiment of the present invention. As shown in the figure, the system 700 comprises: a common endpoint obtaining unit 710 configured to obtain a common endpoint on the road network based on a first set of trajectories; a node aggregating unit 720 configured to aggregate, starting from the common endpoint, a plurality of nodes on the road network based on orientations of a second set of trajectories at the plurality of nodes to generate an aggregated node; and a road network dividing unit 730 configured to divide the road network using the aggregated node.

In one embodiment, the common endpoint obtaining unit 710 may comprise: a trajectory endpoint aggregating unit configured to aggregate, based on distances between trajectory endpoints of the first set of trajectories, the trajectory endpoints to generate the common endpoint.

In one embodiment, the node aggregating unit 720 may comprise: a diffusiveness determining unit configured to determine diffusiveness of orientations of at least some trajectories in the second set of trajectories at a given node in the plurality of nodes; a first aggregating unit configured to, in response to the diffusiveness being higher than a predetermined threshold, aggregate the given node and a further node in the road network; and a second aggregating unit configured to in response to the diffusiveness being lower than the predetermined threshold, maintain the given node in the road network.

In one embodiment, the diffusiveness determining unit may comprise: a first diffusiveness determining unit configured to in response to the common endpoint being a start point, calculate entropy associated with the given node based on ratios of trajectories, in the at least some trajectories, that extend from the given node along different orientations.

In one embodiment, the diffusiveness determining unit may comprise: a second diffusiveness determining unit configured to in response to the common endpoint being a terminal point, calculate entropy associated with the given node based on ratios of trajectories, in the at least some trajectories, that arrive at the given node from different orientations.

In one embodiment, the node aggregating unit 720 may comprise: a third aggregating unit configured to aggregate the plurality of nodes based on the orientations and a distribution density of the plurality of nodes.

In one embodiment, the road network is converted into a graph for facilitating division. The road network dividing unit 730 may comprise: an edge creating unit configured to create an edge between the aggregated node and a further node in a graph that represents the road network; and a weight determining unit configured to determine a weight for the edge for dividing the road network based on an initial weight for at least one node covered by the aggregated node and the further node, the initial weight being determined based on at least one of the following: the number of trajectories in the second set of trajectories that pass through the at least one node and the further node, and a distance between the at least one node and the further node in the road network.

In one embodiment, the road network is converted into a graph for facilitating division. The road network dividing unit 730 may comprise: a weight reducing unit configured to in response to a length of a given trajectory in the second set of trajectories exceeding a predetermined threshold, at least partially reduce a contribution of the given trajectory to a weight of a respective edge in the graph.

It should be noted that for the sake of clarity, FIG. 7 does not show optional units or sub-units included in the system 700. All features and operations as described above are suitable for system 700, respectively, which are therefore not detailed here. Moreover, partitioning of units or subunits in system 700 is exemplary, rather than limitative, intended to describe its main functions or operations logically. A function of one unit may be implemented by a plurality of other units; on the contrary, a plurality of units may be implemented by one unit. The scope of the present invention is not limited in this aspect.

Moreover, the units included in the system 700 may be implemented by various manners, including software, hardware, firmware or a random combination thereof. For example, in some embodiments, the apparatus may be implemented by software and/or firmware. Alternatively or additionally, the system 700 may be implemented partially or completely based on hardware. for example, one or more units in the system 700 may be implemented as an integrated circuit (IC) chip, an application-specific integrated circuit (ASIC), a system on chip (SOC), a field programmable gate array (FPGA), and the like. The scope of the present intention is not limited to this aspect.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of dividing a road network comprising:
obtaining a common endpoint on the road network based on a first set of trajectories;
aggregating, starting from the common endpoint, a plurality of nodes on the road network based on orientations of a second set of trajectories at the plurality of nodes to generate an aggregated node; and
dividing the road network using the aggregated node.

2. The method according to claim 1, wherein obtaining a common endpoint on the road network based on a first set of trajectories comprises:
aggregating, based on distances between trajectory endpoints of the first set of trajectories, the trajectory endpoints to generate the common endpoint.

3. The method according to claim 1, wherein aggregating the plurality of nodes on the road network based on orientations of the second set of trajectories at the plurality of nodes comprises:
determining diffusiveness of orientations of at least some trajectories in the second set of trajectories at a given node in the plurality of nodes;
in response to the diffusiveness being higher than a predetermined threshold, aggregating the given node and a further node in the road network; and
in response to the diffusiveness being lower than the predetermined threshold, maintaining the given node in the road network.

4. The method according to claim 3, wherein determining diffusiveness of orientations of at least some trajectories in the second set of trajectories at the given node in the plurality of nodes comprises:
in response to the common endpoint being a start point, calculating entropy associated with the given node based on ratios of trajectories in the at least some trajectories that extend from the given node along different orientations.

5. The method according to claim 3, wherein determining diffusiveness of orientations of at least some trajectories in the second set of trajectories at the given node in the plurality of nodes comprises:
in response to the common endpoint being a terminal point, calculating entropy associated with the given node based on ratios of trajectories in the at least some trajectories that arrive at the given node from different orientations.

6. The method according to claim 1, wherein aggregating the plurality of nodes on the road network based on orientations of the second set of trajectories at the plurality of nodes comprises:
aggregating the plurality of nodes based on the orientations and a density of distribution of the plurality of nodes.

7. The method according to claim 1, wherein dividing the road network using the aggregated node comprises:
creating an edge between the aggregated node and a further node in a graph that represents the road network; and
determining a weight for the edge for dividing the road network based on an initial weight for at least one node covered by the aggregated node and the further node, the initial weight being determined based on at least one of the following:
the number of trajectories in the second set of trajectories that pass through the at least one node and the further node, and
a distance between the at least one node and the further node in the road network.

8. The method according to claim 7, wherein dividing the road network using the aggregated node comprises:
in response to a length of a given trajectory in the second set of trajectories exceeding a predetermined threshold, at least partially reducing a contribution of the given trajectory to a weight of a respective edge in the graph.

9. A system for dividing a road network comprising:
a common endpoint obtaining unit configured to obtain a common endpoint on the road network based on a first set of trajectories;
a node aggregating unit configured to aggregate, starting from the common endpoint, a plurality of nodes on the road network based on orientations of a second set of trajectories at the plurality of nodes to generate an aggregated node; and
a road network dividing unit configured to divide the road network using the aggregated node.

10. The system according to claim 9, wherein the common endpoint obtaining unit comprises:
a trajectory endpoint aggregating unit configured to aggregate, based on distances between trajectory endpoints of the first set of trajectories, the trajectory endpoints to generate the common endpoint.

11. The system according to claim 9, wherein the node aggregating unit comprises:
a diffusiveness determining unit configured to determine diffusiveness of orientations of at least some trajectories in the second set of trajectories at a given node in the plurality of nodes;
a first aggregating unit configured to, in response to the diffusiveness being higher than a predetermined threshold, aggregate the given node and a further node in the road network; and
a second aggregating unit configured to, in response to the diffusiveness being lower than the predetermined threshold, maintain the given node in the road network.

12. The system according to claim 11, wherein the diffusiveness determining unit comprises:
a first diffusiveness determining unit configured to, in response to the common endpoint being a start point, calculate entropy associated with the given node based on ratios of trajectories in the at least some trajectories that extend from the given node along different orientations.

13. The system according to claim 11, wherein the diffusiveness determining unit comprises:
a second diffusiveness determining unit configured to, in response to the common endpoint being a terminal point, calculate entropy associated with the given node based on ratios of trajectories in the at least some trajectories that arrive at the given node from different orientations.

14. The system according to claim 9, wherein the node aggregating unit comprises:
a third aggregating unit configured to aggregate the plurality of nodes based on the orientations and a density of distribution of the plurality of nodes.

15. The system according to claim 9, wherein the road network dividing unit comprises:
an edge creating unit configured to create an edge between the aggregated node and a further node in a graph that represents the road network; and
a weight determining unit configured to determine a weight for the edge for dividing the road network based on an initial weight for at least one node covered by the aggregated node and the further node, the initial weight being determined based on at least one of the following:
the number of trajectories in the second set of trajectories that pass through the at least one node and the further node, and
a distance between the at least one node and the further node in the road network.

16. The system according to claim 15, wherein the road network dividing unit comprises:
a weight reducing unit configured to in response to a length of a given trajectory in the second set of trajectories exceeding a predetermined threshold, at least partially reduce a contribution of the given trajectory to a weight of a respective edge in the graph.

17. A computer program product for dividing a road network comprising a computer readable storage medium having computer readable program code embodied therewith, the computer readable program code, when executed by a processor, causing the processor to:
obtain a common endpoint on the road network based on a first set of trajectories;
aggregate, starting from the common endpoint, a plurality of nodes on the road network based on orientations of a second set of trajectories at the plurality of nodes to generate an aggregated node; and
divide the road network using the aggregated node.

18. The computer program product according to claim 17, wherein obtaining a common endpoint on the road network based on a first set of trajectories comprises aggregating, based on distances between trajectory endpoints of the first set of trajectories, the trajectory endpoints to generate the common endpoint.

19. The computer program product according to claim 17, wherein aggregating the plurality of nodes on the road network based on orientations of the second set of trajectories at the plurality of nodes comprises:
determining diffusiveness of orientations of at least some trajectories in the second set of trajectories at a given node in the plurality of nodes;
in response to the diffusiveness being higher than a predetermined threshold, aggregating the given node and a further node in the road network; and
in response to the diffusiveness being lower than the predetermined threshold, maintaining the given node in the road network.

20. The computer program product according to claim 19, wherein determining diffusiveness of orientations of at least some trajectories in the second set of trajectories at the given node in the plurality of nodes comprises calculating entropy associated with the given node based on ratios of trajectories in the at least some trajectories that extend from the given node along different orientations, in response to the common endpoint being a start point.
